(19) United States
(12) Patent Application Publication
(10) Pub. No.: US 2022/0023962 A1
(43) Pub. Date: Jan. 27, 2022

(54) Machine Tool

(71) Applicant: Robert Bosch GmbH, Stuttgart (DE)

(72) Inventors: Gregory A. Menze, Mount Prospect, IL (US); Jana Bieser, Ludwigsburg (DE); Tina Ringshandl, Leinfelden (DE); Plamen V. Marinov, Mount Prospect, IL (US); Philipp Freiburger, Stuttgart (DE)

(21) Appl. No.: 17/414,239

(22) PCT Filed: Dec. 10, 2019
(86) PCT No.: PCT/EP2019/084434

§ 371 Date: Jun. 15, 2021

(30) Foreign Application Priority Data
Dec. 18, 2018 (DE) 10 2018 222 159.6

(51) Int. Cl. B23D 45/04; B23D 47/12; B23D 47/02

(52) U.S. Cl. CPC B23D 45/046; B23D 47/02; B23D 47/12

(57) ABSTRACT

A machine tool, in particular a chop saw and/or miter saw, includes (i) at least one pivot arm, (ii) at least one drive unit arranged on the pivot arm, (iii) at least two energy storage units, in particular battery packs, which can be electrically connected in series, for supplying energy to the drive unit, and (iv) at least two coupling units for fastening the energy storage units to the pivot arm. The coupling units are arranged on the pivot arm at an offset to one another with respect to a longitudinal axis of the pivot arm, the longitudinal axis of the pivot arm running at least substantially parallel to coupling surfaces, in particular main extension planes, of the coupling units.

### PRIOR ART

A power tool, in particular a circular cross-cut and/or miter saw, comprising at least one swivel arm, comprising at least one drive unit arranged on the swivel arm, comprising at least two energy storage units, in particular battery packs, that can be electrically connected in series, for supplying energy to the drive unit, and comprising at least two coupling units for fastening the energy storage units to the swivel arm, has already been proposed in U.S. Pat. No. 9,827,622 B2. The coupling units are arranged on the swivel arm, offset from one another as viewed along a longitudinal axis of the swivel arm, in such a manner that the longitudinal axis of the swivel arm is transverse, in particular at least substantially perpendicular, to coupling surfaces, in particular planes of main extent, of the coupling units.

### DISCLOSURE OF THE INVENTION

The invention is based on a power tool, in particular a circular cross-cut and/or miter saw, comprising at least one swivel arm, comprising at least one drive unit arranged on the swivel arm, comprising at least two energy storage units, in particular battery packs, that can be electrically connected in series, for supplying energy to the drive unit, and comprising at least two coupling units for fastening the energy storage units to the swivel arm.

It is proposed that the coupling units be arranged on the swivel arm, offset from one another as viewed along a longitudinal axis of the swivel arm, wherein the longitudinal axis of the swivel arm is at least substantially parallel to coupling surfaces, in particular planes of main extent, of the coupling units.

Preferably, the power tool is realized as a stationary power tool, in particular different from a hand-held power tool. Preferably, the power tool is realized as a saw, in particular as a circular cross-cut and/or miter saw. Alternatively, it is conceivable for the power tool to be realized as a power sander, as a planing machine, as a bench drill, as a milling machine, or as another power tool considered appropriate by persons skilled in the art. The swivel arm is preferably designed to movably support the drive unit of the power tool, and/or at least a tool receiver of the power tool that is designed to receive a working tool, for example a saw blade, a milling head, a drill bit, or the like, in particular relative to at least one workpiece support surface of the power tool. In particular, the swivel arm is mounted so as to be swivelable about a swivel point, in particular about a swivel axis that passes through the swivel point, in particular on a basic unit of the power tool. In particular, the tool receiver is arranged at an end of the swivel arm that faces away from the swivel point. Preferably, the basic unit is designed to be arranged on a base, for example on a floor, a bench, or the like. In particular, the basic unit may have at least one stand foot, preferably a plurality of stand feet, for arrangement on the base. Preferably, the basic unit constitutes, at least portionally, the workpiece support surface of the power tool. In particular, at least one workpiece on which work is to be performed by means of the power tool, in particular by means of the working tool, can be placed on the workpiece support surface. In particular, the swivel arm, in particular the working tool arranged on the swivel arm by means of the tool receiver, can be moved in the direction of the workpiece support surface by an operation of swiveling the swivel arm about the swivel axis, in particular can be brought into contact with a workpiece arranged on the workpiece support surface. Preferably, a working plane, in particular a cutting plane, of the swivel arm can be set. In particular, the swivel arm is mounted, in particular on the basic unit of the power tool, so as to be inclinable transversely in relation to the swivel axis of the swivel arm and transversely in relation to the workpiece support surface, for the purpose of setting the working plane, in particular the cutting plane, of the swivel arm. In particular, the swivel arm is mounted, in particular on the basic unit of the power tool, so as to be inclinable about an inclination axis that is at least substantially parallel to the workpiece support surface and transverse, in particular at least substantially perpendicular, to the swivel axis of the swivel arm. “Substantially parallel” is to be understood to mean, in particular, an alignment of a direction relative to a reference direction, in particular in one plane, the direction deviating with respect to the reference direction by, in particular, less than 8°, advantageously less than 5°, and particularly advantageously less than 2°. The expression “substantially perpendicular” is intended to define, in particular, an alignment of a direction relative to a reference direction, the direction and the relative direction, in particular as viewed in one plane, enclosing an angle of 90° and the angle having a maximum deviation of, in particular, less than 8°, advantageously less than 5°, and particularly advantageously less than 2°. “Designed” is to be understood to mean, in particular, specially programmed, specially configured and/or specially equipped. That an object is designed for a particular function, is to be understood to mean, in particular, that the object fulfils and/or executes this particular function in at least one application state and/or operating state.

The drive unit preferably comprises at least one motor, in particular an electric motor. The drive unit may additionally have, in particular, at least one transmission. Preferably, the drive unit is designed to drive the tool receiver, in particular a working tool received by the tool receiver, to execute a motion, in particular a rotatory motion. In particular, the drive unit, in particular the electric motor of the drive unit, can be operated with electrical energy. The energy storage units, in particular the battery packs, are preferably designed to supply the drive unit with electrical energy. The energy storage units are preferably at least substantially similar to each other in design, in particular in respect of a maximum energy storage capacity and a maximum voltage that can be provided. Preferably, the energy storage units are designed to be electrically connectable in series, in particular for the purpose of realizing a voltage that can be provided as a multiple of, in particular twice, that which can be provided by a single energy storage unit. Preferably, the electric motor of the drive unit can be operated with at least twice the voltage of a single energy storage unit.

The coupling units are preferably designed for mechanical and electrical coupling to the energy storage units. In particular, respectively one of the coupling units is designed for mechanical and electrical coupling to respectively one of the energy storage units. In particular, the coupling units each have at least one contact element for electrical connection to the energy storage units, and at least one fixing element for mechanical connection to the energy storage units. Preferably, the coupling units are fastened to the swivel arm, between the swivel point and the tool receiver as viewed along the longitudinal axis of the swivel arm. The longitudinal axis of the swivel arm is preferably at least substantially perpendicular to the swivel axis of the swivel arm, and in particular in the working plane, in particular the cutting plane. Preferably, for the purpose of supplying energy to the drive unit, the coupling units are connected in an electrically conductive manner, in particular via electrical line elements such as, for example, cables or wires, to the drive unit, in particular to the electric motor of the drive unit.

The coupling units are preferably designed for non-positive and/or positive coupling of the energy storage units. A “coupling surface” of a coupling unit is, in particular, a surface of the coupling unit that has a maximal surface area of all surfaces of the coupling unit in contact with the energy storage unit, against which an energy storage unit bears when having been coupled to the coupling unit. Preferably, the coupling surfaces of the coupling units are arranged at least substantially parallel to the planes of main extent of the coupling units. A “plane of main extent” of an object is to be understood to mean, in particular, a plane that is parallel to a largest lateral surface of a smallest notional cuboid that only just completely encloses the object, and in particular extends through the mid-point of the cuboid. In particular, the fixing elements of the coupling units and the contact elements, in particular contact surfaces of the contact elements, of the coupling units extend at least substantially perpendicularly in relation to the coupling surfaces. Preferably, the coupling units are arranged on the swivel arm in such a manner that the coupling surfaces of the coupling units extend in a common plane. In particular, the coupling units are fastened to the swivel arm at a distance from each other as viewed along the longitudinal axis of the swivel arm. Alternatively, it is conceivable for the coupling units to be fastened to the swivel arm so as to be in contact with each other as viewed along the longitudinal axis of the swivel arm.

The design of the power tool according to the invention makes it possible, advantageously, to achieve a space-saving arrangement of energy storage units on a power tool. Advantageously, a battery-powered power tool can be provided that, at least substantially, is unrestricted in respect of use, in particular with regard to handling safety and with regard to user convenience.

It is furthermore proposed that the power tool comprise at least one tool receiver, in particular the above-mentioned tool receiver, arranged on the swivel arm, for receiving a working tool, in particular a saw blade, wherein the tool receiver has an axis of rotation that is at least substantially perpendicular to a tool plane extending at least substantially parallel to the coupling surfaces, in particular to the planes of main extent, of the coupling units. Preferably, the tool receiver, in particular a working tool received on the tool receiver, can be driven by the drive unit to execute a rotational motion about the axis of rotation of the tool receiver. Preferably, the tool plane of a working tool, in particular of a saw blade, corresponds at least substantially to a plane of main extent of the working tool, in particular of the saw blade. Preferably, the tool plane of a working tool arranged on the tool receiver extends at least substantially parallel to the working plane, in particular the cutting plane, of the swivel arm. Preferably, when the swivel arm is in a state of inclination in which the working plane of the swivel arm is aligned at least substantially perpendicularly in relation to the workpiece support surface, the axis of rotation of the tool receiver is at least substantially parallel to the swivel axis of the swivel arm. Preferably, the axis of rotation of the tool receiver is at least substantially parallel to an axis of rotation of the drive unit, in particular of the electric motor of the drive unit. In particular, the axis of rotation of the tool receiver and the axis of rotation of the drive unit, in particular of the electric motor of the drive unit, are mutually offset as viewed in a direction at least substantially perpendicular to the axes of rotation. Preferably, the drive unit, in particular the electric motor of the drive unit, is designed to drive the tool receiver indirectly. Alternatively, it is conceivable for the axis of rotation of the tool receiver to be coaxial with the axis of rotation of the drive unit, in particular of the electric motor of the drive unit, in particular for the drive unit, in particular the electric motor of the drive unit, to be designed to drive the tool receiver directly. Advantageously, a symmetrical arrangement of the energy storage units on the swivel arm can be achieved, in particular in respect of a weight distribution.

It is also proposed that the power tool comprise at least one workpiece support surface, in particular the above-mentioned workpiece support surface, for receiving at least one workpiece, wherein the energy storage units can be coupled to the coupling units, in particular can be inserted into the coupling units, in a direction from the workpiece support surface toward the swivel arm. In particular, the coupling units each have at least one bearing contact surface that, in particular in at least one state of inclination and swivel state of the swivel arm, is aligned at least substantially parallel to the workpiece support surface and against which an energy storage unit bears when having been coupled to the coupling unit. Preferably, the bearing contact surfaces extend at least substantially perpendicularly in relation to the coupling surfaces. Preferably, the energy storage units have latching elements, in particular latching grooves, which are realized in such a manner that the latching elements latch with the coupling units, in particular with the fixing elements of the coupling units, as a result of an insertion movement of the energy storage units along a direction from the workpiece support surface toward the swivel arm. In particular, the coupling units, in particular the fixing elements of the coupling units, are designed to secure the energy storage units, when having been coupled to the coupling units, against falling out of the coupling units in the direction of the workpiece support surface. Advantageously, a power tool that is convenient to operate can be provided.

It is furthermore proposed that the energy storage units, when having been coupled to the coupling units, be arranged at least substantially entirely within a region defined by a maximum extent of the drive unit, in particular in a plane transverse to the workpiece support surface. Preferably, the plane transverse to the workpiece support surface extends at least substantially parallel to the tool plane and to the working plane, in particular to the cutting plane. In particular, the drive unit, as viewed in the plane transverse to the workpiece support surface, in particular at least substantially perpendicularly in relation to the longitudinal axis of the swivel arm and transversely in relation to the swivel axis of the swivel arm, has a maximum extent that corresponds at least to a maximum extent of the energy storage units, when having been coupled to the coupling units, as viewed in the plane transverse to the workpiece support surface, in particular at least substantially perpendicularly in relation to the longitudinal axis of the swivel arm and transversely in relation to the swivel axis of the swivel arm. In particular, the region defined by the maximum extent of the drive unit is arranged between two notional planes, extending at least substantially parallel to one another and to the longitudinal axis of the swivel arm, that extend, at least substantially perpendicularly in relation to the maximum extent of the drive unit, in the plane transverse to the workpiece support surface. Advantageously, a compact arrangement of the energy storage units on the swivel arm can be achieved, which advantageously makes the power tool easy to handle.

It is additionally proposed that the coupling units each have at least one fixing element, in particular the above-mentioned fixing element, for mechanical connection to the energy storage units, which extends at least substantially perpendicularly in relation to the longitudinal axis of the swivel arm and at least substantially parallel to at least a swivel axis of the swivel arm. In particular, at least one longitudinal axis of the fixing element extends at least substantially perpendicularly in relation to the longitudinal axis of the swivel arm and at least substantially parallel to the swivel axis of the swivel arm, in particular at least substantially perpendicularly in relation to the coupling surfaces of the coupling units and at least substantially parallel to the bearing contact surfaces of the coupling units. Preferably, the fixing elements are fastened to the coupling surfaces, in particular are realized integrally with the coupling surfaces. “Integrally” is to be understood to mean, in particular, formed in one piece. Preferably, this one piece is produced from a single blank, a compound or a casting, particularly preferably in an injection molding process, in particular a single-component or multi-component injection molding process. Preferably, the fixing elements are realized as latching elements, as snap-in elements, as bayonet elements, or as other fixing elements considered appropriate by persons skilled in the art. In particular, the coupling units each have at least one fixing element, preferably at least two fixing elements, and particularly preferably at least three fixing elements. Advantageously, a space-saving arrangement of the energy storage units on the swivel arm can be made possible with, at the same time, secure fastening.

It is furthermore proposed that the coupling units each comprise at least one contact element, in particular the above-mentioned contact element, for electrical connection to the energy storage units, which has a plane of main extent that extends at least substantially perpendicularly in relation to the longitudinal axis of the swivel arm and at least substantially parallel to at least a swivel axis of the swivel arm. In particular, the planes of main extent of the contact elements extend at least substantially perpendicularly in relation to the coupling surfaces and to the bearing contact surfaces of the coupling units. Preferably, the contact elements are fastened to the coupling surfaces and/or to the bearing contact surfaces. In particular, the coupling units each have at least one contact element, preferably at least two contact elements, particularly preferably at least three contact elements, and particularly preferably at least four contact elements. Advantageously, a space-saving arrangement of the energy storage units on the swivel arm can be made possible with, at the same time, a stable electrical connection.

It is also proposed that the coupling units, in particular the energy storage units coupled to the coupling units, be arranged between the drive unit and a swivel point of the swivel arm, as viewed along the longitudinal axis of the swivel arm. In particular, the coupling units, in particular the energy storage units coupled to the coupling units, are arranged between the tool receiver and the swivel point of the swivel arm, as viewed along the longitudinal axis of the swivel arm. Preferably the region defined by the maximum extent of the drive unit, in particular in the plane transverse to the workpiece support surface, extends at least substantially from the drive unit to the swivel point of the swivel arm, as viewed along the swivel arm. An advantageous weight distribution along the swivel arm can be achieved, which in particular provides for an advantageous ease of handling of the power tool.

It is furthermore proposed that lateral surfaces of the energy storage units, when having been coupled to the coupling units, face toward one another, as viewed along a direction that is at least substantially parallel to the longitudinal axis of the swivel arm. A “lateral surface” of an energy storage unit is realized, in particular, as an outer surface of the energy storage unit that, when the energy storage unit has been coupled to a coupling unit, is arranged without contact to the coupling surface and to the bearing contact surface of the coupling unit, and extends at least substantially perpendicularly in relation to the coupling surface and to the bearing contact surface of the coupling unit. Preferably, when the energy storage units have been coupled to the coupling units, the lateral surfaces of the energy storage units extend at least substantially perpendicularly in relation to the longitudinal axis of the swivel arm and at least substantially parallel to the swivel axis of the swivel arm. Preferably, the mutually facing lateral surfaces of two energy storage units are shielded from one another at most portionally by lateral guides of the coupling units. Advantageously, it is possible to achieve a compact arrangement of the energy storage units in a direction parallel to the swivel axis of the swivel arm.

It is additionally proposed that the energy storage units, when having been coupled to the coupling units, be arranged at least substantially perpendicularly in relation to the longitudinal axis of the swivel arm, at least portionally offset in the direction of at least one workpiece support surface, in particular the above-mentioned workpiece support surface, relative to an axis of rotation of the drive unit. In particular, the energy storage units, when having been coupled to the coupling units, are arranged at least substantially perpendicularly in relation to the longitudinal axis of the swivel arm, at least portionally offset in the direction of the workpiece support surface relative to the axis of rotation of the electric motor of the drive unit. Preferably, at least geometric mid-points, in particular centroids, of the energy storage units, when having been coupled to the coupling units, are arranged at least substantially perpendicularly in relation to the longitudinal axis of the swivel arm, at least portionally offset in the direction of the workpiece support surface relative to the axis of rotation of the drive unit, in particular of the electric motor of the drive unit. An advantageous distribution of mass on the swivel arm can be achieved, which in particular provides for an advantageous ease of handling of the power tool.

It is furthermore proposed that the energy storage units be realized as 18-volt battery packs. In particular, the energy storage units are designed to provide a voltage of 18 V. Preferably, the electric motor of the drive unit is realized as a 36-volt electric motor. In particular, the electric motor can be operated with a voltage of 36 V. In particular, the electric motor can be operated with the added voltage of two energy storage units. Preferably, the coupling units are electrically connected in series in such a manner that the coupling units can provide the electric motor of the drive unit with twice the voltage of a single energy storage unit coupled, respectively, to one of the coupling units. Preferably, the energy storage units are realized as lithium-ion battery packs, as lithium-polymer battery packs, as nickel-cadmium battery packs, or as other battery packs considered appropriate by persons skilled in the art. Advantageously, a powerful drive unit can be driven by means of two less powerful energy storage units, which can be arranged in a space-saving manner on the swivel arm.

The power tool according to the invention is not intended in this case to be limited to the application and embodiment described above. In particular, the power tool according to the invention may have individual elements, component parts and units that differ in number from a number stated herein, in order to fulfill an operating principle described herein. Moreover, in the case of the value ranges specified in this disclosure, values lying within the stated limits are also to be deemed as disclosed and applicable in any manner.

### DRAWINGS

Further advantages are disclosed by the following description of the drawings. The drawings show an exemplary embodiment of the invention. The drawings, the description and the claims contain numerous features in combination. Persons skilled in the art will also expediently consider the features individually and combine them to create appropriate further combinations.

There are shown:

FIG. 1 a power tool according to the invention, in a perspective representation,

FIG. 2 the power tool according to the invention from FIG. 1, in a schematic representation,

FIG. 3 a swivel arm of the power tool according to the invention from FIG. 1, in a perspective representation, and

FIG. 4 coupling units of the power tool according to the invention from FIG. 1, in a perspective representation.

### DESCRIPTION OF THE EXEMPLARY EMBODIMENT

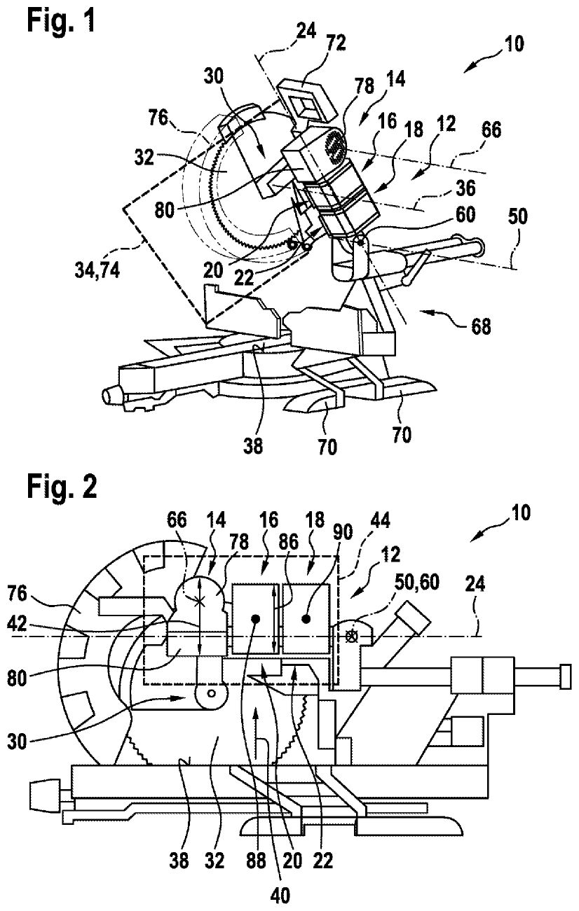

FIG. 1 shows a power tool 10 in a perspective representation. Preferably, the power tool 10 is realized as a stationary power tool, in particular different from a hand-held power tool. Preferably, the power tool 10 is realized as a saw, in particular as a circular cross-cut and/or miter saw. In the present exemplary embodiment, the power tool 10 is realized, by way of example, as a circular cross-cut and/or miter saw.

Alternatively, it is conceivable for the power tool 10 to be realized as a power sander, as a planing machine, as a bench drill, as a milling machine, or as another power tool considered appropriate by persons skilled in the art. Preferably, the power tool 10, in particular the circular cross-cut and/or miter saw, comprises at least one swivel arm 12, at least one drive unit 14 arranged on the swivel arm 12, at least two energy storage units 16, 18, in particular battery packs, that can be electrically connected in series, for supplying energy to the drive unit 14, and at least two coupling units 20, 22 for fastening the energy storage units 16, 18 to the swivel arm 12. In the present exemplary embodiment, the power tool 10 comprises, for example, one coupling unit 20 that is designed for coupling to an energy storage unit 16, and a further coupling unit 22 that is designed for coupling to a further energy storage unit 18. Preferably, the coupling units 20, 22 units are arranged on the swivel arm 12, offset from one another as viewed along a longitudinal axis 24 of the swivel arm 12, the longitudinal axis 24 of the swivel arm 12 being at least substantially parallel to coupling surfaces 26, 28, in particular planes of main extent, of the coupling units 20, 22 (cf. FIG. 4).

The swivel arm 12 is preferably designed for mounting the drive unit 14 of the power tool 10 and/or at least one tool receiver 30 of the power tool 10 that is designed to receive a working tool 32, for example a saw blade, a milling head, a drill bit, or the like, in a movable manner, in particular relative to at least one workpiece support surface 38 of the power tool 10. In the present exemplary embodiment, the working tool 32 is realized, by way of example, as a saw blade. In particular, the swivel arm 12 is mounted, in particular on a basic unit 68 of the power tool 10, so as to be swivelable about a swivel point 60, in particular about a swivel axis 50 that passes through the swivel point 60. In particular, the tool receiver 30 is arranged at an end of the swivel arm 12 that faces away from the swivel point 60. Preferably, the basic unit 68 is designed to be arranged on a base, for example on a floor, a bench, or the like (not shown further here). In particular, the basic unit may have at least one stand foot 70, preferably a plurality of stand feet 70, for arrangement on the base. Preferably, the basic unit 68 constitutes, at least portionally, the workpiece support surface 38 of the power tool 10. In particular, at least one workpiece on which work is to be performed by means of the power tool 10, in particular by means of the working tool 32, can be placed on the workpiece support surface 38. In particular, the swivel arm 12, in particular the working tool 32 arranged on the swivel arm 12 by means of the tool receiver 30, can be moved in the direction of the workpiece support surface 38 by an operation of swiveling the swivel arm 12 about the swivel axis 50, in particular can be brought into contact with a workpiece arranged on the workpiece support surface 38. In particular, fastened to the swivel arm 12 is a handle 72 of the power tool 10, for actuating the swivel arm 12. Preferably, a working plane 74, in particular a cutting plane, of the swivel arm 12 can be set. In particular, the swivel arm 12 is mounted, in particular on the basic unit 68 of the power tool 10, so as to be inclinable transversely in relation to the swivel axis 50 of the swivel arm 12 and transversely in relation to the workpiece support surface 38, for the purpose of setting the working plane 74, in particular the cutting plane, of the swivel arm 12. In particular, the swivel arm 12 is mounted, in particular on the basic unit 68 of the power tool 10, so as to be inclinable about an inclination axis that is at least substantially parallel to the workpiece support surface and transverse, in particular at least substantially perpendicular, to the swivel axis 50 of the swivel arm 12. In particular, the power tool 10 comprises a protective hood 76, mounted in a movable manner on the swivel arm 12, for protecting an operator of the power tool 10 from the working tool 32.

The drive unit 14 preferably comprises at least one motor, in particular an electric motor 78. The drive unit 14 may additionally have, in particular, at least one transmission 80. Preferably, the drive unit 14 is designed to drive the tool receiver 30, in particular a working tool 32 received by the tool receiver 30, to execute a motion, in particular a rotatory motion. In particular, the drive unit 14, in particular the electric motor 78 of the drive unit 14, can be operated with electrical energy. The energy storage units 16, 18, in particular the battery packs, are preferably designed to supply the drive unit 14 with electrical energy. The energy storage units 16, 18 are preferably at least substantially similar to each other in design, in particular in respect of a maximum energy storage capacity and a maximum voltage that can be provided. Preferably, the energy storage units 16, 18 are designed to be electrically connectable in series, in particular for the purpose of realizing a voltage that can be provided as a multiple of, in particular twice, that which can be provided by a single energy storage unit 16, 18. Preferably, the electric motor 78 of the drive unit 14 can be operated with at least twice the voltage of a single energy storage unit 16, 18.

The coupling units 20, 22 are preferably designed for mechanical and electrical coupling to the energy storage units 16, 18. In particular, respectively one of the coupling units 20, 22 is designed for mechanical and electrical coupling to respectively one of the energy storage units 16, 18. In particular, the coupling units 20, 22 each have at least one contact element 52, 54 for electrical connection to the energy storage units 16, 18, and at least one fixing element 46, 48 for mechanical connection to the energy storage units 16, 18 (cf. FIG. 4). Preferably, the coupling units 20, 22 are fastened to the swivel arm 12, between the swivel point 60 and the tool receiver 30 as viewed along the longitudinal axis 24 of the swivel arm 12. The longitudinal axis 24 of the swivel arm 12 is preferably at least substantially perpendicular to the swivel axis 50 of the swivel arm 12, and in particular in the working plane 74, in particular the cutting plane. Preferably, for the purpose of supplying energy to the drive unit 14, the coupling units 20, 22 are connected in an electrically conductive manner, in particular via electrical line elements such as, for example, cables or wires, to the drive unit 14, in particular to the electric motor 78 of the drive unit 14.

Preferably, the energy storage units 16, 18 are realized as 18-volt battery packs. In particular, the energy storage units 16, 18 are designed to provide a voltage of 18 V. Preferably, the electric motor 78 of the drive unit 14 is realized as a 36-volt electric motor. In particular, the electric motor can be operated with a voltage of 36 V. In particular, the electric motor 78 can be operated with the added voltage of two energy storage units 16, 18. Preferably, the coupling units 20, 22 are electrically connected in series in such a manner that the coupling units 20, 22 can provide the electric motor 78 of the drive unit 14 with twice the voltage of a single energy storage unit 16, 18 coupled, respectively, to one of the coupling units 20, 22. Preferably, the energy storage units 16, 18 are realized as lithium-ion battery packs, as lithium-polymer battery packs, as nickel-cadmium battery packs, or as other battery packs considered appropriate by persons skilled in the art.

The coupling units 20, 22 are preferably designed for non-positive and/or positive coupling of the energy storage units 16, 18. Preferably, the coupling surfaces 26, 28 of the coupling units 20, 22 are arranged at least substantially parallel to the planes of main extent of the coupling units 20, 22. In particular, the fixing elements 46, 48 of the coupling units 20, 22 and the contact elements 52, 54, in particular contact surfaces of the contact elements 52, 54, of the coupling units 20, extend at least substantially perpendicularly in relation to the coupling surfaces 26, 28 (cf. FIG. 4). Preferably, the coupling units 20, 22 are arranged on the swivel arm 12 in such a manner that the coupling surfaces 26, 28 of the coupling units 20, 22 extend in a common plane. In particular, the coupling units 20, 22 are fastened to the swivel arm 12 at a distance from each other as viewed along the longitudinal axis 24 of the swivel arm 12. Alternatively, it is conceivable for the coupling units 20, 22 to be fastened to the swivel arm 12 so as to be in contact with each other as viewed along the longitudinal axis 24 of the swivel arm 12.

Preferably, the power tool 10 comprises at least one tool receiver, in particular the above-mentioned tool receiver 30, arranged on the swivel arm 12, for receiving a working tool 32, in particular a saw blade, the tool receiver 30 having an axis of rotation 36 that is at least substantially perpendicular to a tool plane 34 extending at least substantially parallel to the coupling surfaces 26, 28, in particular to the planes of main extent, of the coupling units 20, 22. Preferably, the tool receiver 30, in particular a working tool 32 received on the tool receiver 30, can be driven by the drive unit 14 to execute a rotational motion about the axis of rotation 36 of the tool receiver 30. Preferably, the tool plane 34 of a working tool, in particular of a saw blade, corresponds at least substantially to a plane of main extent of the working tool 32, in particular of the saw blade. Preferably, the tool plane 34 of the working tool arranged 32 on the tool receiver 30 extends at least substantially parallel to the working plane 74, in particular the cutting plane, of the swivel arm 12. Preferably, when the swivel arm 12 is in a state of inclination in which the working plane 74 of the swivel arm 12 is aligned at least substantially perpendicularly in relation to the workpiece support surface 38, the axis of rotation 36 of the tool receiver 30 is at least substantially parallel to the swivel axis 50 of the swivel arm 12. Preferably, the axis of rotation 36 of the tool receiver 30 is at least substantially parallel to an axis of rotation 66 of the drive unit 14, in particular of the electric motor 78 of the drive unit 14. In particular, the axis of rotation 36 of the tool receiver 30 and the axis of rotation 66 of the drive unit 14, in particular of the electric motor 78 of the drive unit 14, are mutually offset as viewed in a direction at least substantially perpendicular to the axes of rotation 36, 66. Preferably, the drive unit 14, in particular the electric motor 78 of the drive unit 14, is designed to drive the tool receiver 30 indirectly. Alternatively, it is conceivable for the axis of rotation 36 of the tool receiver 30 to be coaxial with the axis of rotation 66 of the drive unit 14, in particular of the electric motor 78 of the drive unit 14, in particular for the drive unit 14, in particular the electric motor 78 of the drive unit 14, to be designed to drive the tool receiver 30 directly.

FIG. 2 shows the power tool 10 from FIG. 1 in a schematic representation. In FIG. 2 the power tool 10 is represented in a swivel state of the swivel arm 12 in which the working tool 32 is in contact with the workpiece support surface 38, whereas in FIG. 1 the power tool 10 is represented in a swivel state of the swivel arm 12 in which the working tool 32 is at a distance from the workpiece support surface 38.

Preferably, the power tool 10 comprises at least one workpiece support surface, in particular the above-mentioned workpiece support surface 38, for receiving at least one workpiece, the energy storage units 16, 18 being able to be coupled to the coupling units 20, 22, in particular being able to be inserted into the coupling units 20, 22, in a direction from the workpiece support surface 38 toward the swivel arm 12. In particular, the coupling units 20, 22 each have at least one bearing contact surface 82, 84 that, in particular in at least one state of inclination and swivel state of the swivel arm 12, is aligned at least substantially parallel to the workpiece support surface 38 and against which an energy storage unit 16, 18 bears when having been coupled to the coupling unit 20, 22 (cf. FIG. 4). Preferably, the bearing contact surfaces 82, 84 extend at least substantially perpendicularly in relation to the coupling surfaces 26, 28. Preferably, the energy storage units 16, 18 have latching elements, in particular latching grooves, which are realized in such a manner that the latching elements latch with the coupling units 20, 22, in particular with the fixing elements 46, 48 of the coupling units 20, 22, as a result of an insertion movement of the energy storage units 16, 18 along a direction from the workpiece support surface 38 toward the swivel arm 12. In particular, the coupling units 20, 22, in particular the fixing elements 46, 48 of the coupling units 20, 22, are designed to secure the energy storage units 16, 18, when having been coupled to the coupling units 20, 22, against falling out of the coupling units 20, 22 in the direction of the workpiece support surface 38.

Preferably, the energy storage units 16, 18, when having been coupled to the coupling units 20, 22, are arranged at least substantially entirely within a region defined by a maximum extent 42 of the drive unit 14, in particular in a plane 44 transverse to the workpiece support surface 38. Preferably, the plane 44 transverse to the workpiece support surface 38 extends at least substantially parallel to the tool plane 34 and to the working plane 74, in particular to the cutting plane. In particular, the drive unit 14, as viewed in the plane 44 transverse to the workpiece support surface 38, in particular at least substantially perpendicularly in relation to the longitudinal axis 24 of the swivel arm 12 and transversely in relation to the swivel axis 50 of the swivel arm 12, has a maximum extent 42 that corresponds at least to a maximum extent 86 of the energy storage units 16, 18, when having been coupled to the coupling units 20, 22, as viewed in the plane 44 transverse to the workpiece support surface 38, in particular at least substantially perpendicularly in relation to the longitudinal axis 24 of the swivel arm 12 and transversely in relation to the swivel axis 50 of the swivel arm 12. In particular, the region defined by the maximum extent 42 of the drive unit 14 is arranged between two notional planes, extending at least substantially parallel to one another and to the longitudinal axis 24 of the swivel arm 12, that extend, at least substantially perpendicularly in relation to the maximum extent 42 of the drive unit 14, in the plane 44 transverse to the workpiece support surface 38.

Preferably, the coupling units 20, 22, in particular the energy storage units 16, 18 coupled to the coupling units 20, 22, are arranged between the drive unit 14 and a swivel point 60 of the swivel arm 12, as viewed along the longitudinal axis 24 of the swivel arm 12. In particular, the coupling units 20, 22, in particular the energy storage units 16, 18 coupled to the coupling units 20, 22, are arranged between the tool receiver 30 and the swivel point 60 of the swivel arm 12, as viewed along the longitudinal axis 24 of the swivel arm 12. Preferably the region defined by the maximum extent 42 of the drive unit 14, in particular in the plane 44 transverse to the workpiece support surface 38, extends at least substantially from the drive unit 14 to the swivel point 60 of the swivel arm 12, as viewed along the swivel arm 12.

Preferably, the energy storage units 16, 18, when having been coupled to the coupling units 20, 22, are arranged at least substantially perpendicularly in relation to the longitudinal axis 24 of the swivel arm 12, at least portionally offset in the direction of at least one workpiece support surface, in particular the above-mentioned workpiece support surface 38, relative to an axis of rotation 66 of the drive unit 14. In particular, the energy storage units 16, 18, when having been coupled to the coupling units 20, 22, are arranged at least substantially perpendicularly in relation to the longitudinal axis 24 of the swivel arm 12, at least portionally offset in the direction of the workpiece support surface 38 relative to the axis of rotation 66 of the electric motor 78 of the drive unit 14. Preferably, at least geometric mid-points 88, 90, in particular centroids, of the energy storage units 16, 18, when having been coupled to the coupling units 20, 22, are arranged at least substantially perpendicularly in relation to the longitudinal axis 24 of the swivel arm 12, at least portionally offset in the direction of the workpiece support surface 38 relative to the axis of rotation 66 of the drive unit 14, in particular of the electric motor 78 of the drive unit 14.

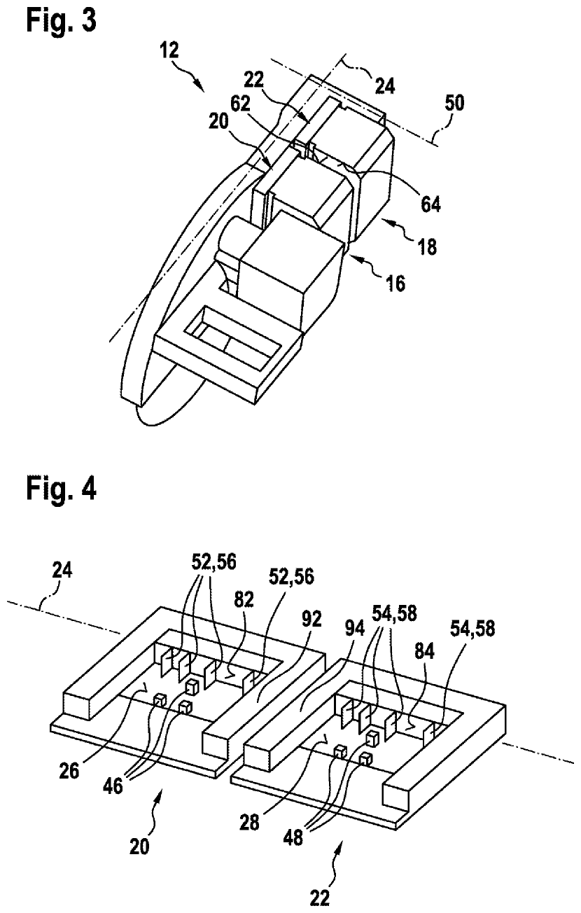

FIG. 3 shows the swivel arm 12 of the power tool 10 from FIG. 1 in a perspective representation. Preferably, lateral surfaces 62, 64 of the energy storage units 16, 18, when having been coupled to the coupling units 20, 22, face toward one another, as viewed along a direction that is at least substantially parallel to the longitudinal axis 24 of the swivel arm 12. A lateral surface 62 of the energy storage unit 16 faces, in particular, toward a lateral surface 64 of the further energy storage unit 18. Preferably, when the energy storage units 16, 18 have been coupled to the coupling units 20, 22, the lateral surfaces 62, 64 of the energy storage units 16, 18 extend at least substantially perpendicularly in relation to the longitudinal axis 24 of the swivel arm 12 and at least substantially parallel to the swivel axis 50 of the swivel arm 12. Preferably, the mutually facing lateral surfaces 62, 64 of the two energy storage units 16, 18 are shielded from one another at most portionally by lateral guides 92, 94 of the coupling units 20, 22 (cf. FIG. 4).

FIG. 4 the coupling units 20, 22 of the power tool 10 from FIG. 1 in a perspective representation. Preferably, the coupling units 20, 22 each have at least one fixing element, in particular the at least one above-mentioned fixing element 46, 48, for mechanical connection to the energy storage units 16, 18, which extends at least substantially perpendicularly in relation to the longitudinal axis 24 of the swivel arm 12 and at least substantially parallel to at least a swivel axis 50 of the swivel arm 12. In particular, the coupling units 20, each have at least one fixing element 46, 48, preferably at least two fixing elements 46, 48, and particularly preferably at least three fixing elements 46, 48. In the present exemplary embodiment, the coupling unit 20 has, for example, three fixing elements 46 and the further coupling unit 22 has, for example, three fixing elements 48. In particular, longitudinal axes of the fixing elements 46, 48 extend at least substantially perpendicularly in relation to the longitudinal axis 24 of the swivel arm 12 and at least substantially parallel to the swivel axis 50 of the swivel arm 12, in particular at least substantially perpendicularly in relation to the coupling surfaces 26, 28 of the coupling units 20, 22 and at least substantially parallel to the bearing contact surfaces 82, 84 of the coupling units 20, 22. Preferably, the fixing elements 46, 48 are fastened to the coupling surfaces 26, 28, in particular are realized integrally with the coupling surfaces 26, 28. Preferably, the fixing elements 46, 48 are realized as latching elements, as snap-in elements, as bayonet elements, or as other fixing elements considered appropriate by persons skilled in the art.

Preferably, the coupling units 20, 22 each comprise at least one contact element, in particular the at least one above-mentioned contact element 52, 54, for electrical connection to the energy storage units 16, 18, which has a plane of main extent 56, 58 that extends at least substantially perpendicularly in relation to the longitudinal axis 24 of the swivel arm 12 and at least substantially parallel to at least a swivel axis 50 of the swivel arm 12. In particular, the coupling units 20, each have at least one contact element 52, 54, preferably at least two contact elements 52, 54, particularly preferably at least three contact elements 52, 54, and particularly preferably at least four contact elements 52, 54. In the present exemplary embodiment, the coupling unit 20 has, for example, four contact elements 52 and the further coupling unit 22 has, for example, four contact elements 54. In particular, the planes of main extent 56, 58 of the contact elements 52, extend at least substantially perpendicularly in relation to the coupling surfaces 26, 28 and to the bearing contact surfaces 82, 84 of the coupling units 20, 22. Preferably, the contact elements 52, 54 are fastened to the coupling surfaces 26, 28 and/or to the bearing contact surfaces 82, 84.

1. A power tool, comprising:
at least one swivel arm;
at least one drive unit arranged on the swivel arm;
at least two energy storage units electrically connected in series and configured to supply energy to the drive unit
at least two coupling units configured to fasten the energy storage units to the swivel arm,
wherein the coupling units are arranged on the swivel arm offset from one another as viewed along a longitudinal axis of the swivel arm, and
wherein the longitudinal axis of the swivel arm is at least substantially parallel to coupling surfaces of the coupling units.

2. The power tool as claimed in claim 1, further comprising at least one tool receiver, arranged on the swivel arm, for receiving a working tool
wherein the tool receiver has an axis of rotation that is at least substantially perpendicular to a tool plane extending at least substantially parallel to the coupling surfaces of the coupling units.

3. The power tool as claimed in claim 1, further comprising at least one workpiece support surface for receiving at least one workpiece, wherein:
the energy storage units are configured to be coupled to the coupling units.

4. The power tool as claimed in claim 3, wherein the energy storage units, when having been coupled to the coupling units, are arranged at least substantially entirely within a region defined by a maximum extent of the drive unit in a plane transverse to the workpiece support surface.

5. The power tool as claimed in claim 1, wherein the coupling units each have at least one fixing element for mechanical connection to the energy storage units, which extends at least substantially perpendicularly in relation to the longitudinal axis of the swivel arm and at least substantially parallel to at least a swivel axis of the swivel arm.

6. The power tool as claimed in claim 1, wherein the coupling units each comprise at least one contact element for electrical connection to the energy storage units, which has a plane of main extent that extends at least substantially perpendicularly in relation to the longitudinal axis of the swivel arm and at least substantially parallel to at least a swivel axis of the swivel arm.

7. The power tool as claimed in claim 1, wherein the coupling units are arranged between the drive unit and a swivel point of the swivel arm, as viewed along the longitudinal axis of the swivel arm.

8. The power tool as claimed in claim 1, wherein lateral surfaces of the energy storage units, when having been coupled to the coupling units, face toward one another, as viewed along a direction that is at least substantially parallel to the longitudinal axis of the swivel arm.

9. The power tool as claimed in claim 1, wherein the energy storage units, when having been coupled to the coupling units, are arranged at least substantially perpendicularly in relation to the longitudinal axis of the swivel arm, at least portionally offset in the direction of at least one workpiece support surface relative to an axis of rotation of the drive unit.

10. The power tool as claimed in claim 1, wherein the energy storage units include 18-volt battery packs.

11. The power tool as claimed in claim 1, wherein the power tool is one of a circular cross-cut saw and a miter saw.

12. The power tool as claimed in claim 1, wherein the energy storage units include battery packs.

13. The power tool as claimed in claim 1, wherein the longitudinal axis of the swivel arm is further at least substantially parallel to planes of main extent of the coupling units.

14. The power tool as claimed in claim 1, further comprising at least one tool receiver, arranged on the swivel arm, that is configured to receive a saw blade, wherein:
the at least one tool receiver has an axis of rotation that is at least substantially perpendicular to the tool plane extending at least substantially parallel to the planes of main extent of the coupling units.

15. The power tool as claimed in claim 3, wherein the energy storage units are configured to be inserted into the coupling units in a direction from the workpiece support surface toward the swivel arm.
